(19) United States
(12) Patent Application Publication
(10) Pub. No.: US 2024/0289894 A1
(43) Pub. Date: Aug. 29, 2024

(54) SYSTEMS AND METHODS FOR DYNAMICALLY DETERMINING PREVAILING WAGES

(71) Applicant: PW Resources, LLC, San Diego, CA (US)

(72) Inventors: Cari Honey, San Diego, CA (US); Brittni Engle, San Diego, CA (US)

(21) Appl. No.: 18/587,043

(22) Filed: Feb. 26, 2024

Related U.S. Application Data
(60) Provisional application No. 63/487,058, filed on Feb. 27, 2023.

(51) Int. Cl. G06Q 40/12; G06F 9/451; G06V 10/764

(52) U.S. Cl. CPC G06Q 40/125; G06F 9/451; G06V 10/764

(57) ABSTRACT

Disclosed embodiments may include a system for conducting prevailing wage determinations. The system may receive or retrieve first data, second data associated with one or more users and the first data, and location data associated with the first data, receive or retrieve wage data based on the location data, identify one or more classifications based on the first data and the second data, match the one or more classifications with the wage data, automatically determine one or more compensations based on the associated matched one or more classifications and wage data, wherein the one or more compensations comprises one or more fringe benefit amounts and one or more fringe benefit allocations, generate a first graphical user interface (GUI) comprising the one or more compensations, and cause the system or another computing device to display the first GUI.

### CROSS-REFERENCE TO RELATED APPLICATIONS

This application claims priority under 35 U.S.C. § 119 to the U.S. Provisional Patent Application No. 63/487,058, filed Feb. 27, 2023, entitled, “SYSTEMS AND METHODS FOR DYNAMICALLY DETERMINING PREVAILING WAGES,” the entire contents of which are fully incorporated herein by reference.

### FIELD

The disclosed technology relates to systems and methods for determining prevailing wages, and more particularly, for automatically and dynamically generating and modifying related reports and graphical user interfaces, and providing recommended schedules based on overtime holidays in connection with payroll processing, certification, reporting, and project management.

### BACKGROUND

A prevailing wage is the basic hourly rate of wages and benefits paid to a number of similarly employed workers in a given geography. Policymakers at regulatory agencies, state departments of labor, and the like can use prevailing compensation levels to set wage and benefit floors for workers in the locality. For example, the Davis-Bacon Act and Service Contract Act have long required contractors and subcontractors on federally funded or assisted construction and service contracts to pay locally prevailing wages and provide benefits. Additionally, roughly half of all U.S. states, as well as various cities, have their own prevailing wage laws. Prevailing wages set by these various policymakers are also frequently updated, often while projects are underway.

“Public Works” contractors must keep in mind all applicable prevailing wage laws and frequent updates to set prevailing wages, as they are required in a variety of jurisdictions to pay prevailing wages based on classification of work type and other factors such as geographic location of the construction site, and to provide certified payroll records (“CPRs”), among other things. CPRs are intended to serve as prima facie evidence of the wages paid and any fringe benefit contributions made, to or on behalf of each worker on the project, broken down by craft, type, or classification of work, per hour, and per day, along with various information items related to the project, the awarding body, and the employees working thereupon. Used herein, “Public Works” is meant to describe work done by a non-governmental entity contractor employer that performs construction, alteration, demolition, installation or repair work consistent with California Labor Code § 1720 et. seq., United States Code Davis-Bacon and Related Acts Title 40 U.S.C. § 3141 et. seq., and all other similar laws and regulations of any states and any political subdivisions therein, and not the same term as used, for example, as the title name of Title 21 California Code of Regulations which governs such things as the State Architect's Office and the Department of Transportation.

Determining the appropriate prevailing wage often proves to be complex and overwhelming for Public Works contractors, and quickly grows in difficulty for projects extending for long periods of time, crossing over into multiple jurisdictions, or hiring several types of professionals. Some Public Works contractors have manually tried to determine and track prevailing wages for payroll processing, certification, reporting, and project management, while others have turned to automated payroll systems to handle core payroll processing and reports, but both approaches are limited. For example, traditional systems and methods fail to consider intricacies of prevailing wage determinations, distinguish prevailing wage determinations based on locale, and generate fringe benefit statements when making prevailing wage determinations. Furthermore, traditional systems and methods fail to provide tools for a user to adjust one or more schedules to minimize unnecessary overtime.

Accordingly, there is a need for improved systems and methods for determining prevailing wages. Embodiments of the present disclosure are directed to this and other considerations.

### SUMMARY

Disclosed embodiments may include an automated prevailing wage determination system. The system may include one or more processors, and memory in communication with the one or more processors and storing first instructions that are configured to cause the system to perform a method for determining prevailing wages for a contractor (e.g., a Public Works contractor). The system may receive or retrieve first data (e.g., a project initiation date, a project description including whether the project is a public works or a private works, project cost, a project type, a projected completion date), second data associated with one or more users (e.g., employees) and the first data, and location data (e.g., address of the project) associated with the first data. The system may receive or retrieve wage data (e.g., wage data classifications and one or more wage rates based on the wage data classifications) based on the location data. Based on the first and second data related to the project and users, the system may identify one or more classifications and match the one or more classifications with the wage data. The system may automatically determine one or more compensations (e.g., including one or more fringe benefit amounts and one or more fringe benefit allocations) based on the matched one or more classifications and wage data, before generating a first graphical user interface (GUI) with the one or more compensations. The system may then cause the first GUI to be displayed (e.g., on a display device that is part of the system or on another computing device).

In other disclosed embodiments, the automated prevailing wage determination system may include one or more processors, and memory in communication with the one or more processors and storing first instructions that are configured to cause the system to perform a method for determining prevailing wages and schedules for a contractor. The system may receive or retrieve first data (e.g., related to the project as described above) and location data. Based on the location data, the system may also receive or retrieve wage data. The system may generate a first schedule for one or more users based on the first data, and cause one or more user devices to display a GUI with the first schedule for one or more users based on the first data. If the particular user has worked sufficient hours to qualify for overtime, the system may identify overtime based on first data and wage data, and determine whether the first schedule comprises the overtime. When it does, the system may cause the one or more user devices to modify the GUI to comprise an indication of the overtime.

In further disclosed embodiments, the automated prevailing wage determination system may include one or more processors, and memory in communication with the one or more processors and storing first instructions that are configured to cause the system to perform a method for determining prevailing wages for a contractor. The system may receive or retrieve first data (e.g., associated with a project as described above), second data associated with one or more users, and location data. The system may receive or retrieve wage data based on the location data, and identify one or more classifications based on the first data and the second data. The system may then match the one or more classifications with the wage data, and automatically determine one or more compensations (e.g., including one or more fringe benefit amounts and one or more fringe benefit allocations) based on the matched one or more classifications and wage data. The system may also generate one or more fringe benefit statements associated with the one or more classifications and based on the one or more fringe benefit amounts and the one or more fringe benefit allocations, and cause the system or another computing device to display the one or more fringe benefit statements. As the project information changes, the system may receive modified first data and, in turn, identify one or more classifications changes based on the modified first data. The system may generate one or more modified fringe benefit statements based on the one or more classifications, and cause the system or another computing device to display the one or more modified fringe benefit statements in a GUI.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for determining compensation for prevailing wages, according to an example implementation of the disclosed technology.

FIG. 2 is a flow diagram illustrating an exemplary method for identifying and indicating overtime and overtime holidays, according to an example implementation of the disclosed technology.

FIG. 3 is a flow diagram illustrating an exemplary method for generating and displaying fringe benefit statements, according to an example implementation of the disclosed technology.

FIG. 4 is a block diagram of an example prevailing wage determination system used to at least determine compensation, identify and indicate overtime and/or overtime holidays, and generate and display fringe benefit statements, according to an example implementation of the disclosed technology.

FIG. 5 is a block diagram of an example system used to test architecture resiliency, in accordance with certain embodiments of the disclosed technology.

### DETAILED DESCRIPTION

Traditional systems and methods for determining compensation or fringe benefits involving prevailing wages typically involve inaccurate calculations, inaccurate or hard to modify fringe benefit statements, inaccurate certified payroll or other contractor reports, or fail to identify financial savings (e.g., tax savings) for a contractor. These system and methods typically involve spreadsheets and rely on user input. Thus, traditional systems and methods fail to consider intricacies of prevailing wage determinations, distinguish prevailing wage determinations based on locale, and accurately determine and generate fringe benefit statements when making prevailing wage determinations. Furthermore, traditional systems and methods fail to provide tools for a user to adjust one or more schedules to minimize unnecessary overtime.

Accordingly, examples of the present disclosure relate to determining compensation or fringe benefits involving prevailing wages and providing tools and a dynamic graphical user interface with recommendations to minimize unnecessary overtime. The systems and methods described herein are thus necessarily rooted in computer and technology as they utilize, in some instances, graphical user interfaces (GUIs), which are a computer technology that allows for user interaction with computers through touch, pointing devices, or other means. Additionally, the systems and methods described herein improve, in some instances, the operation of computers and technology by dynamically and automatically modifying one or more GUIs based on determining or detecting changes in compensation, fringe benefits, classification, project data, or overtime. Additionally, the system may receive and process geofence data and determinations in order to improve the determinations of the system and methods. These are all improvements in the overall operation of systems and related devices.

This may provide an advantage and improvement over prior technologies that may not provide a way to automatically and dynamically making prevailing wage compensation determinations. Embodiments of the present disclosure solve this problem by providing a system the receives, extracts, and identifies relevant prevailing wage information based on project data, employee or user data, and location or jurisdiction data. Furthermore, examples of the present disclosure may also improve the speed with which computers can generate prevailing wage determinations, indications, recommendations, reports, and statements. Overall, the systems and methods disclosed have significant practical applications in the prevailing wage software field because of the noteworthy improvements of the customized prevailing wage determinations, indications, recommendations, reports, and statements as well as associated dynamic GUIs, which are important to solving present problems with this technology.

Disclosed embodiments may employ machine learning models (MLMs), among other computerized techniques, to provide recommendations for rules that may be of interest to, and/or provide certain incentives to, certain users. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to evaluate rules associated with a first user, and recommend one or more of those rules to a second user based on, for example, similarities between the first and second users, and/or respective interactions of the first and second users with various types of external devices. This, in some examples, may involve using user-specific input data and an MLM, applied to determine prevailing wages and associated compensation or scheduling that may be applicable and/or of interest to different users based on users' similarities (e.g., interests, day-to-day activities, habits, etc.). Using an MLM and a computer system configured in this way may allow the system to provide a customized prevailing wage determination, schedule, reports, and associated GUIs based on a variety of user-specific input data.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

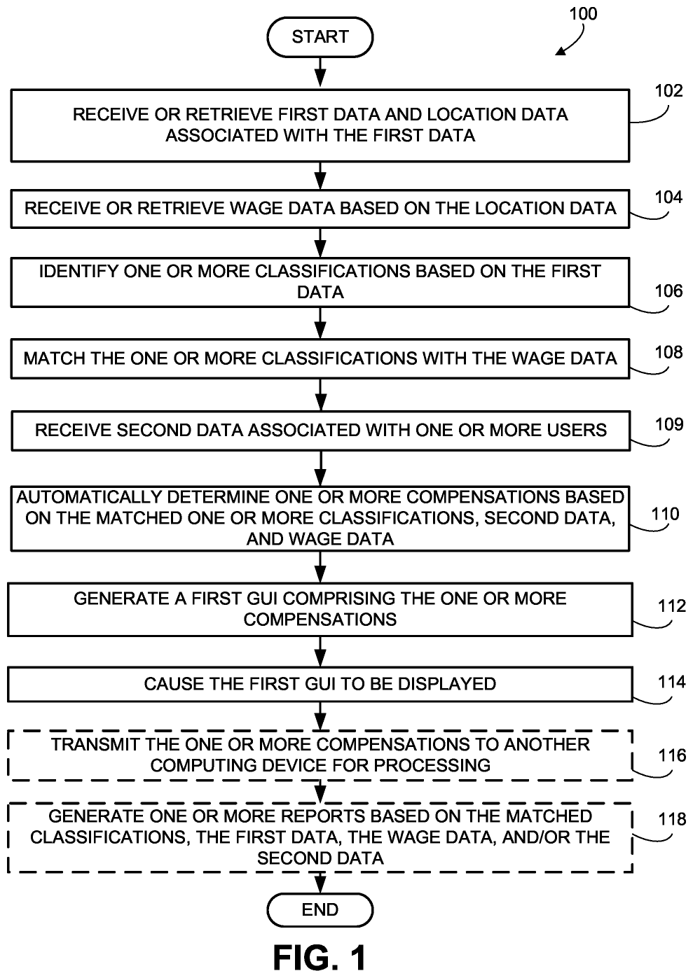

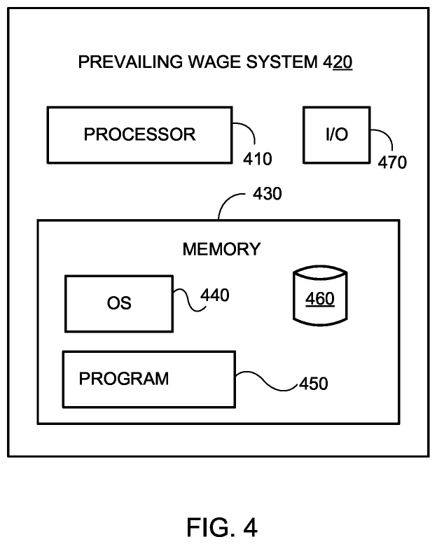

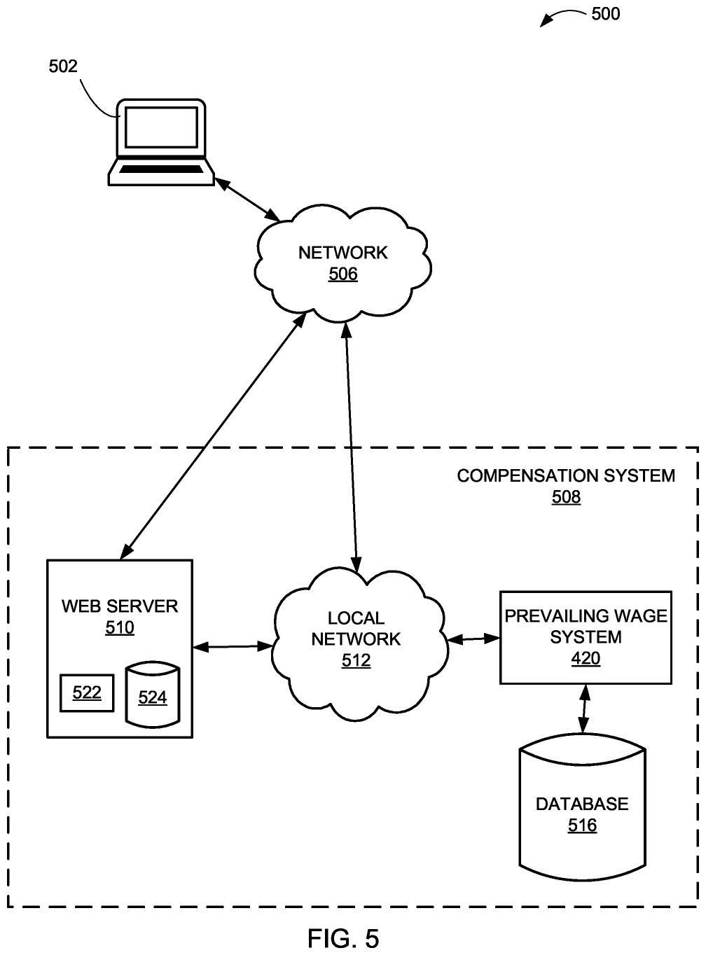

FIG. 1 is a flow diagram illustrating an exemplary method for determining compensation for prevailing wages, according to an example implementation of the disclosed technology. The steps of method 100 may be performed by one or more components of the system 500 (e.g., prevailing wage system 420 or web server 510 of compensation system 508, or user device 502), as described in more detail with respect to FIGS. 4 and 5. While certain blocks may be identified as being optional, certain embodiments may omit blocks even if they are not necessarily identified as being optional.

In block 102, prevailing wage system 420 may receive or retrieve first data and location data associated with the first data. This data may be received via a first GUI generated by or associated with prevailing wage system 420 displayed on a user device 502 that may supply the first data, the second data, and/or the location data. The first data may include project data associated with a project such as a construction, demolition, repair, installation, or other Public Works project. For example, the first data may include, but not limited to, a project initiation date, a project description including whether the project is a public works or a private works, project cost, a project type (e.g., road construction, bridge construction, office construction), a projected completion date, or combinations thereof. The location data may be the location where the project will take place. This may include an address, radius, building, county, city, or combinations thereof. In some cases, the location data may include geolocation data associated with the project.

The prevailing wage system 420 may determine whether prevailing wages apply to the first data. For example, the prevailing wage system 420 may retrieve and identify current prevailing wage qualifications associated with the location data from regulations and laws found in a database such as database 516. Alternatively, the prevailing wage system 420 may retrieve and identify current prevailing wage qualifications from regulations and laws associated with the location data from national and local government agency website or databases. Other methods of obtaining current prevailing wage qualifications are envisioned. Regardless, the prevailing wage system 420 may compare the prevailing wage qualifications to the first data (e.g., does the first data indicate the project is a public works with a cost over $1,000). Based on the comparison, the prevailing wage system 420 may determine that prevailing wages apply (e.g., project is a public works project in California with a cost over $1,000) or does not apply to the first data (a private works project or a public works project under $1,000 in California). Responsive to determining that the prevailing wages does not apply, prevailing wage system 420 may generate and transmit a notification to a user device 502 from which the first data was received indicating that the prevailing wages do not appear to be required. Responsive to determining the prevailing wages applies, prevailing wage system 420 may (i) receive or retrieve the wage data based on the location data (see at least the description of block 104), (ii) identify the one or more classifications based on the first data and the second data (see at least the description of block 106), (iii) match the one or more classifications with the wage data (see at least the description of block 108), (iv) automatically determine the one or more compensations based on the associated one or more matched classifications and the wage data (see at least the description of block 110), and (v) generate the report comprising the one or more compensations based on the one or more matched classifications, the first data, the second data, and the wage data (see at least the description of block 118); and (vi) cause the system or another computing device (e.g., user device 502) to display the report in the second GUI. The one or more compensations retrieve wage data by scraping a database or website such as database 516.

In block 104, prevailing wage system 420 may receive or retrieve wage data based on the location data. For example, the prevailing wage system 420 my retrieve from a database (e.g., database 516) or the internet, via a web crawler, wage data (e.g., prevailing wage data) associated with the locale indicated by the location data. The wage data may include one or more wage data classifications about the data along with one or more wage rates (including fringe benefit rates) for each of the one or more wage data classifications.

In block 106, prevailing wage system 420 may identify one or more classifications based on the first data. For example, the first data may include a plurality of classifications associated with the project. In this case, prevailing wage system 420 may extract the one or more classifications from the first data. A user, either a supervisor or a worker/employee, may select via one or more GUIs on their user device 502 one or more classifications of the plurality of classifications for time worked on the project. As another example (such as when a user cannot find a proper classification), the second data may include job descriptions and/or one or more images. In this case, prevailing wage system 420 may recognize and classify job description text using natural language processing or other machine learning model trained to recognized and classify text and/or recognize and classify one or more images using a machine learning model trained in object recognition and classification.

In block 108, prevailing wage system 420 may match the one or more classifications with the wage data. Prevailing wage system 420 may compare the one or more classifications with one or more wage data classifications to determine which wages corresponds to the one or more classifications. This may be done by comparing the text or title associated with the one or more classifications and compare that to the descriptions of the classifications. Alternatively, this may be a look up function on a spreadsheet, data table, or other similarly situated data.

In block 109, prevailing wage system 420 may receive or retrieve second data associated with one or more users. This data may be received via a first GUI generated by or associated with prevailing wage system 420 displayed on a user device 502 that may supply the second data. The second data may include user data (e.g., employee data) associated with a contractor and/or the project. For example, the second data may include, but not limited to, a number of employees for the project, one or more classifications for each employee, one or more job types or descriptions for each employee, time each employee worked (or is projected to work) a particular job type, or combinations thereof.

In block 110, prevailing wage system 420 may automatically determine one or more compensations based on the associated matched one or more classifications, wage data, and second data. The one or more compensations may include one or more fringe benefit amounts and a basic pay. Fringe benefits may include health and welfare (e.g. medical insurance contribution, vision insurance contribution, dental insurance contribution, life insurance), retirement contribution (e.g., pension contribution or 401k contribution), vacation and holiday pay, training pay, or combinations thereof. A portion or all of fringe benefits may be converted or added to basic pay. However, if fringe benefits are paid out to the employee the employer is subjected to payroll taxes on the amount.

In some embodiments, the first data or the second data may include one or more fringe benefit allocations. In these instances, prevailing wage system 420 may allocate the one or more fringe benefit amounts according to the one or more fringe benefit allocations. Prevailing wage system 420 may allocate according to a default allocation such as allocating all or a portion of the one or more fringe benefit amounts to basic pay when the first data or second data does not include the one or more fringe benefit allocations. In some instances, prevailing wage system 420 may detect that the first data and the second data do not include one or more fringe benefit allocations and generate and transmit a prompt or indication via the second GUI to a first user device 502 described below that the fringe benefit amount is being paid out to basic pay. In some instances, prevailing wage system 420 may request user input (e.g., via the second GUI on user device 502) to provide one or more fringe benefit allocations, indicate employer tax saving amount associated with allocating the one or more fringe benefits to fringe benefits rather than basic pay, or both. If prevailing wage system 420 receives user input providing one or more fringe benefit allocations, then prevailing wage system 420 may dynamically update and change the allocation and the second GUI of the one or more fringe benefit amounts based on the received one or more fringe benefit allocations.

In some embodiments, determining the one or more compensations may consider one or more overtime benefit caps when calculating fringe benefit amounts such as amounts allotted to a new medical benefit plan. Overtime benefit caps may cap the amount of fringe benefits owed to the employee that worked overtime. For example, in California, if an employee works ten hours in a day, two of those hours are overtime hours where the employee is paid at a rate that is equal to 1.5 times their basic rate based on their job classification. Although the employee is fringe benefits for all ten hours worked, the fringe benefits associated with the overtime pay are not paid or allocated based on the overtime rate. Instead, fringe benefits are required to be paid or allocated for the employee based on the basic rate associated with the classification for the employee. Thus, in some embodiments, prevailing wage system 420 may determine allocated amounts or rates (e.g., premiums) automatically in an annualized amount and in some instances is calculated by age. Prevailing wage system 420 may identify overtime rules (e.g., California Labor Compliance Rules) associated with the location data when determining the one or more compensations described above. Prevailing wage system 420 may also identify at least one user with overtime (e.g., a user that worked 10 hours 2 over which is overtime) according to the overtime rules. Prevailing wage system 420 may also determine whether the overtime rules include an overtime benefit cap (e.g., California rules indicates that fringe benefits are paid at basic rates). Responsive to determining that the overtime rules include the overtime benefit cap, prevailing wage system 420 may determine overtime one or more fringe benefit amounts based on a rate less than one or more overtime rates and indicate in the GUI that the overtime benefit cap applies. Responsive to determining that the overtime rules do not include the overtime benefit cap, prevailing wage system 420 determine one or more overtime fringe benefits amounts based on the one or more overtime rates. The one or more fringe benefit amounts may include the one or more overtime fringe benefit amounts.

In block 112, prevailing wage system 420 may generate the second GUI including the one or more compensations based on the one or more fringe benefit allocations whether default or provided. As mentioned above if one or more fringe benefit allocations have not been received as a part of the first data, second data, or some other source of data, the second GUI may include a request for user input to provide one or more fringe benefit allocations and may indicate an employer tax saving amount associated with allocating the one or more fringe benefits to fringe benefits rather than basic pay, or both. In some embodiments, the second GUI may limit the one or more compensations to one pay period.

In block 114, prevailing wage system 420 may cause the system or another computing device such as user device 502 to display the second GUI.

In optional block 116, the prevailing wage system 420 may transmit the one or more compensations and the one or more fringe benefit allocations to another computing device (e.g., a server with similar components described below with respect to FIG. 4). For example, the prevailing wage system 420 transmit the one or more compensations and one or more fringe benefit allocations to a computing device configured to generate one or more reports based on the matched classifications, the first data, the wage data, and the second data. The prevailing wage system 420 may also cause the computing device to display the report in a third GUI. The one or more reports may include certified payroll reports, contractor compliance reports, or fringe benefit statements.

Instead of another computing device, in optional block 118, prevailing wage system 420 may generate the one or more reports or statements (certified payroll reports, contractor compliance reports, or fringe benefit statements) and associated GUIs based on the matched classifications, the first data, the wage data, and the second data. Prevailing wage system 420 may transmit the one or more reports or statements (certified payroll reports, contractor compliance reports, or fringe benefit statements) and cause a user device 502 to display the one or more reports or statements via one or more associated GUIs.

In some embodiments, prevailing wage system 420 may determine that prevailing wages apply to the first data. Responsive to determining that the prevailing wages does not apply, prevailing wage system 420 may generate and transmit a notification to a user device (e.g., user device 502) from which the first data was received indicating that the prevailing wages do not appear to be required. Alternatively, or in addition, the prevailing wage system 420 may modify the first GUI on a user device 502 to indicate that the prevailing wages do not appear to be required. Responsive to determining the prevailing wages applies, prevailing wage system 420 may perform the actions associated with at least blocks 104 to 114 described above as well as any other corresponding action described herein.

In some embodiments, the second data may include time data and associated geolocation data, both of which may be received on an ongoing dynamic (e.g., real time) basis. This time data and associated geolocation data may be received from one or more user devices (e.g., user device 502) associated with one or more users (e.g., employees). In some embodiments, prevailing wage system 420 may set a geofence based on the first data and the location data. The geofence and location data may be based on Global Navigation Satellite System (GNSS) data, or other wireless signal data. Prevailing wage system 420 may determine whether the associated geolocation data corresponds to the geofence. For example, does the geolocation data indicate a user device 502 is within the geofence. Responsive to determining that the associated geolocation data is within the geofence, prevailing wage system 420 may prompt the user device 502 to confirm that the user is ready to begin work. If prevailing wage system 420 receives user input from user device 502 indicating that the user confirmed she is ready to begin work, prevailing wage system 420 may store the time data received from the at least one first user device (e.g., user device 502). Prevailing wage system 420 may generate a time sheet for the at least one first user associated with the at least one first user device (e.g., user device 502) with stored time data, transmit each time sheet to one or more second user devices (e.g., different user device 502) for display in a fourth GUI, and receive approval of one or more time sheets from the one or more second user devices via the fourth GUI. Generating the one or more compensations is further based on the approved one or more time sheets.

In some embodiments, the second data may include one or more images take by a user device 502. In these embodiments, prevailing wage system 420 may dynamically determine whether the matched one or more classifications are accurate. Responsive to dynamically determining at least one matched classification of the one or more matched classifications are not accurate, prevailing wage system 420 may cause one or more user devices to display a second GUI comprising a prompt or indication of a discrepancy and one or more editable fields with at least one editable field of the one or more editable fields associated with the at least one matched classification, receive modified classification data via the at least one editable field, and modify the first GUI based on the modified classification data.

In some embodiments, prevailing wage system 420 may dynamically determine whether the matched one or more classifications are accurate by comparing, via a machine learning model trained to detect similarities in images, the one or more images to one or more stored images associated with the one or more classifications. In some embodiments, prevailing wage system 420 may dynamically determine whether the matched one or more classifications are accurate by identifying, via a machine learning model trained to detect objects in images associated with the one or more classifications, an object in the one or more images indicative of the one or more classifications.

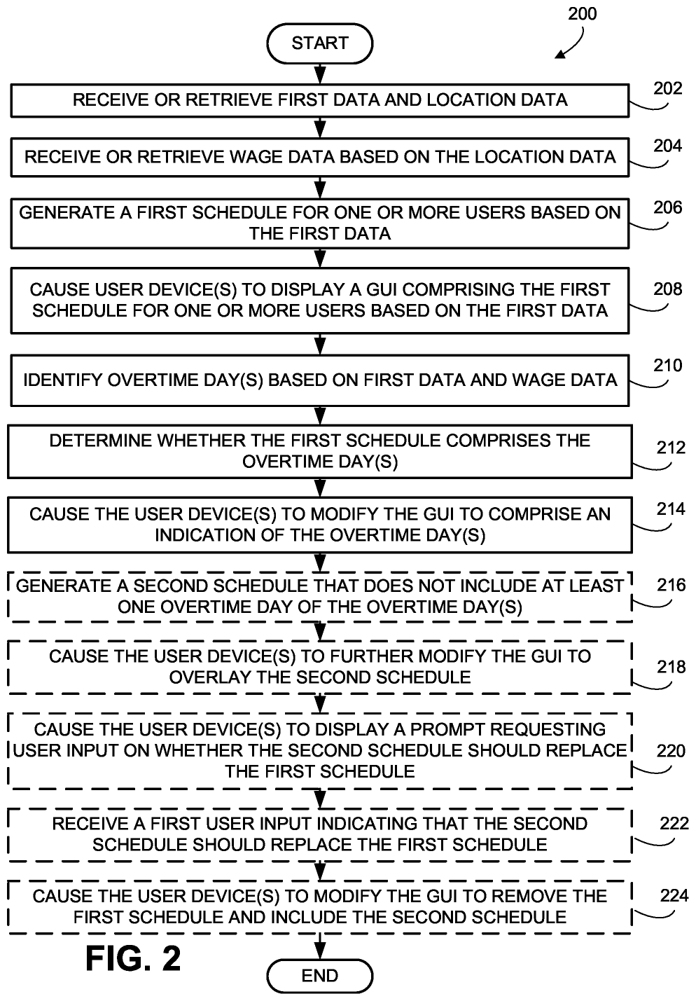

FIG. 2 is a flow diagram illustrating an exemplary method for identifying and indicating overtime and overtime holidays, according to an example implementation of the disclosed technology. The steps of method 200 may be used to identify and avoid unnecessary overtime in a plan submitted by a contractor The steps of method 200 may be performed by one or more components of the system 500 (e.g., prevailing wage system 420 or web server 510 of compensation system 508, or user device 502), as described in more detail with respect to FIGS. 4 and 5. While certain blocks may be identified as being optional, certain embodiments may omit blocks even if they are not necessarily identified as being optional.

In block 202, prevailing wage system 420 may receive or retrieve first data and location data. The first data and location data may include similar data as described above with respect to method 100. In some embodiments, prevailing wage system 420 may also receive or retrieve second data (e.g., employee data related to a particular contractor). The second data may include similar data as discussed above and may include past classifications or job skills for each employee.

In block 204, prevailing wage system 420 may receive or retrieve wage data based on the location data similar to method 100. In some embodiments, prevailing wage system 420 may verify the project is a prevailing wage project as discussed above before preforming the steps outlined in block 204 and below. The wage data may include overtime requirements based on hours per day and particular days for a classification that qualify as a holiday and trigger overtime pay.

In block 206, prevailing wage system 420 may generate a first schedule for one or more users based on the first data. For example, the first schedule may project how many hours per employee classification is needed to finish the project by the completion date. As a further example, if the project must be completed in one week, requires 400 hours of work in a first classification, and the contractor has eight (8) employees capable of working in the first classification, then prevailing wage system 420 may generate a schedule where each of the eight employees work 50 hours split evenly over five weekdays or 10 hours a day.

In block 208, prevailing wage system 420 may cause one or more user devices 502 to display a GUI including the first schedule for one or more users based on the first data.

In block 210, prevailing wage system 420 may identify overtime based on the first data and the wage data. In some embodiments, identifying overtime may include identifying overtime holidays some of which may be unique to a particular classification.

In block 212, prevailing wage system 420 may determine whether the first schedule comprises the overtime. Prevailing wage system 420 may make this determination by comparing the calendar days of the first schedule with the one or more overtime holidays. In some embodiments, prevailing wage system 420 may determine that each of the five days includes 2 hours of overtime based on the wage data as described above. As another example, prevailing wage system 420 may determine that the first schedule includes one or more overtime holidays where a threshold number of hours are scheduled.

In block 214, prevailing wage system 420 may cause the one or more user devices 502 to modify the GUI to include an indication of the overtime. For example, prevailing wage system 420 may change the color, font, size of the schedule or calendar dates associated with the one or more overtime dates.

In optional block 216, prevailing wage system 420 may generate a second schedule that reduces the amount of overtime. For example, based on the first data prevailing wage system 420 may move the hours schedules to work on a holiday to one or more weeks days directly before or after the holiday. If project completion date allows, the entire schedule can shift forward in time by one day to account for the overtime holiday.

In optional block 218, prevailing wage system 420 may cause the one or more user devices 502 to further modify the GUI to overlay the second schedule. For example, one calendar may be shown where a first schedule is shown in a first font and/or color and second schedule in a second font and/or color. Alternatively, prevailing wage system 420 may show the two calendars side by side or in different tabs or windows.

In optional block 220, prevailing wage system 420 may cause the one or more user devices 502 to display a prompt requesting user input on whether the second schedule should replace the first schedule. This prompt may include a button for yes or no or confirmation.

In optional block 222, prevailing wage system 420 may receive a first user input indicating that the second schedule should replace the first schedule. The prompt and its buttons may be temporary which may expire after a predetermined amount of time in which case prevailing wage system 420 may remove the second schedule from the GUI.

In optional block 224, prevailing wage system 420 may cause the one or more user devices 502 to modify the GUI to remove the first schedule and include the second schedule or modify the first schedule based on the second schedule.

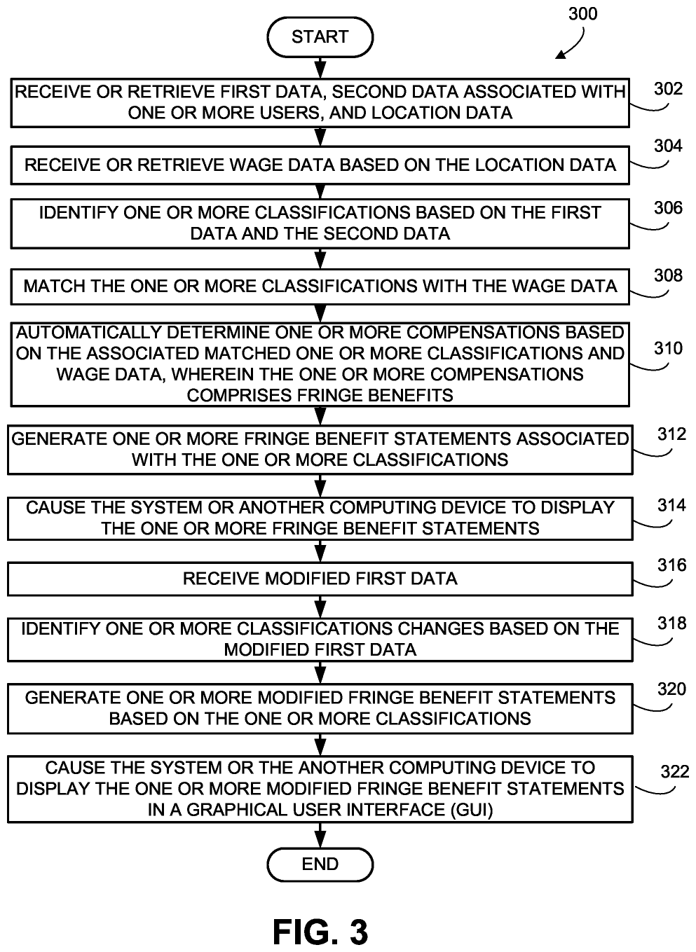

FIG. 3 is a flow diagram illustrating an exemplary method for generating and displaying fringe benefit statements, according to an example implementation of the disclosed technology. The steps of method 300 may be performed by one or more components of the system 500 (e.g., prevailing wage system 420 or web server 510 of compensation system 508, or user device 502), as described in more detail with respect to FIGS. 4 and 5. While certain blocks may be identified as being optional, certain embodiments may omit blocks even if they are not necessarily identified as being optional. Additionally, the description of similar blocks and feature described above may be applicable to method 300.

In block 302, prevailing wage system 420 may receive or retrieve first data, second data associated with one or more users, and location data. In block 304, prevailing wage system 420 may receive or retrieve wage data based on the location data. In block 306, prevailing wage system 420 may identify one or more classifications based on the first data and the second data. In block 308, prevailing wage system 420 may match the one or more classifications with the wage data. In block 310, prevailing wage system 420 may automatically determine one or more compensations based on the associated matched one or more classifications and wage data, wherein the one or more compensations comprises fringe benefits. In block 312, prevailing wage system 420 may generate one or more fringe benefit statements associated with the one or more classifications. In block 314, prevailing wage system 420 may cause the system or another computing device to display the one or more fringe benefit statements. In block 316, prevailing wage system 420 may receive modified first data. In block 318, prevailing wage system 420 may identify one or more classifications changes based on the modified first data. In block 320, prevailing wage system 420 may generate one or more modified fringe benefit statements based on the one or more classifications. In block 322, prevailing wage system 420 may cause the system or another computing device 502 to display the one or more modified fringe benefit statements in a graphical user interface (GUI).

In some embodiments, a federal, state, or local government may implement a change order with a contractor to alter the scope surrounding a project. The change order may be received by the system as first data described above and may include an effective date. For example, software used to implement the above systems and methods may include a graphical user interface that includes a button on Federal Projects to select a change order and enter its effective date. The compensation determinations of method 100, overtime determinations of method 200, and fringe benefit determinations of method 300 may incorporate the change order (including scope, cost, and schedule) and its effective date. The systems (e.g., prevailing wage system 420) makes the new determinations and projections automatically.

Some embodiments may include real-time apprenticeship determination to track a ratio of apprentice to journeymen. For example, California has a minimum apprentice hourly ratio of five journeymen hours per one apprentice hour. As described in method 100, prevailing wage system 420 may receive second data associated with one or more users. This second data may include information indicating whether the user is an apprentice or a journeyman and prevailing wage system 420 may determine whether the number of apprentice hours is exceeding a threshold level (e.g., 1 apprentice hour per 5 journeyman hours or 0.5 apprentice hours per 5 journeyman hours). When prevailing wage system 420 determines that the number of apprentice hours exceeds a set or dynamic threshold, prevailing wage system 420 may generate and transmit an alert to the contractor with a warning that more journeymen need to be assigned to a certain job category, the apprentice needs to be reassigned to a qualified non-apprentice role, or an apprentice needs to be removed until more journeymen arrive or more journeymen in the same job category clock enough hours. In some embodiments, when prevailing wage system 420 determines that the number of apprentice hours is below a set or dynamic lower threshold (e.g., 0.1 apprentice hours per 5 journeymen hours), prevailing wage system 420 may generate and transmit an alert to the contractor to indicate that there is availability for apprentice hours. In some embodiments, the prevailing wage system 420 may reallocate an apprentice to a journeymen or vice versa based on the determination.

FIG. 4 is a block diagram of an example prevailing wage system 420 used to test architecture resiliency, according to an example implementation of the disclosed technology. According to some embodiments, the user device 502 and web server 510, as depicted in FIG. 5 and described below, may have a similar structure and components that are similar to those described with respect to prevailing wage system 420 shown in FIG. 4. As shown, the prevailing wage system 420 may include a processor 410, an input/output (I/O) device 470, a memory 430 containing an operating system (OS) 440 and a program 450.

In certain example implementations, the prevailing wage system 420 may be a single server or may be configured as a distributed computer system including multiple servers or computers that interoperate to perform one or more of the processes and functionalities associated with the disclosed embodiments. In some embodiments prevailing wage system 420 may be one or more servers from a serverless or scaling server system. In some embodiments, the prevailing wage system 420 may further include a peripheral interface, a transceiver, a mobile network interface in communication with the processor 410, a bus configured to facilitate communication between the various components of the prevailing wage system 420, and a power source configured to power one or more components of the prevailing wage system 420.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area network (WAN) or local area network (LAN). In some embodiments, a mobile network interface may include hardware, firmware, and/or software that allow(s) the processor(s) 410 to communicate with other devices via wired or wireless networks, whether local or wide area, private or public, as known in the art. A power source may be configured to provide an appropriate alternating current (AC) or direct current (DC) to power components.

The processor 410 may include one or more of a microprocessor, microcontroller, digital signal processor, co-processor or the like or combinations thereof capable of executing stored instructions and operating upon stored data. The memory 430 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 430.

The processor 410 may be one or more known processing devices, such as, but not limited to, a microprocessor from the Core ^{TM}family manufactured by Intel™, the Ryzen™ family manufactured by AMD™, or a system-on-chip processor using an ARM™ or other similar architecture. The processor 410 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 410 may be a single core processor that is configured with virtual processing technologies. In certain embodiments, the processor 410 may use logical processors to simultaneously execute and control multiple processes. The processor 410 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the prevailing wage system 420 may include one or more storage devices configured to store information used by the processor 410 (or other components) to perform certain functions related to the disclosed embodiments. In one example, the prevailing wage system 420 may include the memory 430 that includes instructions to enable the processor 410 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The prevailing wage system 420 may include a memory 430 that includes instructions that, when executed by the processor 410, perform one or more processes consistent with the functionalities disclosed herein. Methods, systems, and articles of manufacture consistent with disclosed embodiments are not limited to separate programs or computers configured to perform dedicated tasks. For example, the prevailing wage system 420 may include the memory 430 that may include one or more programs 450 to perform one or more functions of the disclosed embodiments. For example, in some embodiments, the prevailing wage system 420 may additionally manage dialogue and/or other interactions with the customer via a program 450.

The processor 410 may execute one or more programs 450 located remotely from the prevailing wage system 420. For example, the prevailing wage system 420 may access one or more remote programs that, when executed, perform functions related to disclosed embodiments.

The memory 430 may include one or more memory devices that store data and instructions used to perform one or more features of the disclosed embodiments. The memory 430 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 430 may include software components that, when executed by the processor 410, perform one or more processes consistent with the disclosed embodiments. In some embodiments, the memory 430 may include a database 460 for storing related data to enable the prevailing wage system 420 to perform one or more of the processes and functionalities associated with the disclosed embodiments.

The database 460 may include stored data relating to status data (e.g., average session duration data, location data, idle time between sessions, and/or average idle time between sessions) and historical status data. According to some embodiments, the functions provided by the database 460 may also be provided by a database that is external to the prevailing wage system 420, such as the database 416 as shown in FIG. 4.

The prevailing wage system 420 may also be communicatively connected to one or more memory devices (e.g., databases) locally or through a network. The remote memory devices may be configured to store information and may be accessed and/or managed by the prevailing wage system 420. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The prevailing wage system 420 may also include one or more I/O devices 470 that may comprise one or more interfaces for receiving signals or input from devices and providing signals or output to one or more devices that allow data to be received and/or transmitted by the prevailing wage system 420. For example, the prevailing wage system 420 may include interface components, which may provide interfaces to one or more input devices, such as one or more keyboards, mouse devices, touch screens, track pads, trackballs, scroll wheels, digital cameras, microphones, sensors, and the like, that enable the prevailing wage system 420 to receive data from a user (such as, for example, via the user device 502).

In examples of the disclosed technology, the prevailing wage system 420 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The prevailing wage system 420 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The prevailing wage system 420 may be configured to adjust model parameters during training. Model parameters may include weights, coefficients, offsets, or the like. Training may be supervised or unsupervised.

The prevailing wage system 420 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The prevailing wage system 420 may be configured to optimize statistical models using known optimization techniques.

Furthermore, the prevailing wage system 420 may include programs configured to retrieve, store, and/or analyze properties of data models and datasets. For example, prevailing wage system 420 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The prevailing wage system 420 may include algorithms to determine a data type, key-value pairs, row-column data structure, statistical distributions of information such as keys or values, or other property of a data schema may be configured to return a statistical profile of a dataset (e.g., using a data-profiling model). The prevailing wage system 420 may be configured to implement univariate and multivariate statistical methods. The prevailing wage system 420 may include a regression model, a Bayesian model, a statistical model, a linear discriminant analysis model, or other classification model configured to determine one or more descriptive metrics of a dataset. For example, prevailing wage system 420 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The prevailing wage system 420 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, prevailing wage system 420 may be configured to generate a similarity metric representing a measure of similarity between data in a dataset. A similarity metric may be based on a correlation, covariance matrix, a variance, a frequency of overlapping values, or other measure of statistical similarity.

The prevailing wage system 420 may be configured to generate a similarity metric based on data model output, including data model output representing a property of the data model. For example, prevailing wage system 420 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The prevailing wage system 420 may be configured to classify a dataset. Classifying a dataset may include determining whether a dataset is related to another dataset. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The prevailing wage system 420 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, prevailing wage system 420 is configured to generate and/or train a classification model to classify a dataset, consistent with disclosed embodiments.

The prevailing wage system 420 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the asset detection system may analyze information applying machine-learning methods.

While the prevailing wage system 420 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the prevailing wage system 420 may include a greater or lesser number of components than those illustrated.

FIG. 5 is a block diagram of an example system that may be used to view and interact with compensation system 408, according to an example implementation of the disclosed technology. The components and arrangements shown in FIG. 5 are not intended to limit the disclosed embodiments as the components used to implement the disclosed processes and features may vary. As shown, compensation system 508 may interact with a user device 502 or other external device(s) (not shown but would have similar components to prevailing wage system 420), via a network 506. In certain example implementations, the compensation system 508 may include a local network 512, prevailing wage system 420, a web server 410, and a database 416.

In some embodiments, a respective user may operate the user device 502. The user device 502 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 506 and ultimately communicating with one or more components of the compensation system 508. In some embodiments, the user device 502 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the compensation system 508. According to some embodiments, the user device 502 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The prevailing wage system 420 may include programs (scripts, functions, algorithms) to configure data for visualizations and provide visualizations of datasets and data models on the user device 502. This may include programs to generate graphs, reports, schedules, and/or calendars and display graphs, reports, schedules, and/or calendars. The prevailing wage system 420 may include programs to generate histograms, scatter plots, time series, or the like on the user device 502. The prevailing wage system 420 may also be configured to display properties of data models and data model training results including, for example, architecture, loss functions, cross entropy, activation function values, embedding layer structure and/or outputs, convolution results, node outputs, or the like on the user device 502.

In some embodiments, external device(s) may include an NFC-enabled device (e.g., having an NFC tag), a smart device (e.g., smart dishwasher, smart TV, etc.), a home assistant device (e.g., a smart speaker), a personal computing device, an analytic device, a fitness tracking device, and the like. A user, such as discussed above, may interact with external device(s) either directly or via a separate user device (e.g., user device 502).

The network 506 may be of any suitable type, including individual connections via the internet such as cellular or WiFi™ networks. In some embodiments, the network 506 may connect terminals, services, and mobile devices using direct connections such as RFID, NFC, Bluetooth™,

BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 506 may include any type of computer networking arrangement used to exchange data. For example, the network 506 may be the Internet, a private data network, virtual private network (VPN) using a public network, and/or other suitable connection(s) that enable(s) components in the system 500 environment to send and receive information between the components of the system 500. The network 506 may also include a PSTN and/or a wireless network.

The compensation system 508 may be associated with and optionally controlled by one or more entities such as a business, corporation, individual, partnership, or any other entity that provides one or more of goods, services, and consultations to individuals such as customers. In some embodiments, the compensation system 508 may be controlled by a third party on behalf of another business, corporation, individual, partnership. The compensation system 508 may include one or more servers and computer systems for performing one or more functions associated with products and/or services that the organization provides.

Web server 510 may include a computer system configured to generate and provide one or more websites accessible to customers, as well as any other individuals involved in accessing compensation system's 508 normal operations. Web server 510 may include a computer system configured to receive communications from user device 502 via for example, a mobile application, a chat program, an instant messaging program, a voice-to-text program, an SMS message, email, or any other type or format of written or electronic communication. Web server 510 may have one or more processors 522 and one or more web server databases 524, which may be any suitable repository of website data. Information stored in web server 510 may be accessed (e.g., retrieved, updated, and added to) via local network 512 and/or network 506 by one or more devices or systems of system 500. In some embodiments, web server 510 may host websites or applications that may be accessed by the user device 502. For example, web server 510 may host a financial service provider website that a user device may access by providing an attempted login that are authenticated by the prevailing wage system 420. According to some embodiments, web server 510 may include software tools, similar to those described with respect to user device 502 above, that may allow web server 510 to obtain network identification data from user device 502. The web server may also be hosted by an online provider of website hosting, networking, cloud, or backup services, such as Microsoft Azure™ or Amazon Web Services™.

The local network 512 may include any type of computer networking arrangement used to exchange data in a localized area, such as WiFi™, Bluetooth™, Ethernet, and other suitable network connections that enable components of the compensation system 508 to interact with one another and to connect to the network 506 for interacting with components in the system 500 environment. In some embodiments, the local network 512 may include an interface for communicating with or linking to the network 506. In other embodiments, certain components of the compensation system 508 may communicate via the network 506, without a separate local network 506.

The compensation system 508 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 502 may be able to compensation system 508 using the cloud computing environment. User device 402 may be able to compensation system 508 using specialized software. The cloud computing environment may eliminate the need to install specialized software on user device 502.

In accordance with certain example implementations of the disclosed technology, the compensation system 508 may include one or more computer systems configured to compile data from a plurality of sources, such as the prevailing wage system 420, web server 510, and/or the database 516. The prevailing wage system 420 may correlate compiled data, analyze the compiled data, arrange the compiled data, generate derived data based on the compiled data, and store the compiled and derived data in a database such as the database 516. According to some embodiments, the database 516 may be a database associated with an organization and/or a related entity that stores a variety of information relating to customers, transactions, ATM, and business operations. The database 516 may also serve as a back-up storage device and may contain data and information that is also stored on, for example, database 460, as discussed with reference to FIG. 4.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### Example Use Case

The following example use case describes an example of a typical user flow pattern. This section is intended solely for explanatory purposes and not in limitation.

In one example, a contractor may engage a prevailing wage specialist to help determine and manage prevailing wage determinations for payroll and government compliance for a construction project. The contractor may provide first data (e.g., project data), second data (e.g., employee/user data and fringe benefit allocations), and location data (e.g., an address of where the project will be located) to the prevailing specialist via a user device 502 or some other computing device. In turn, prevailing wage system 420 may receive the first data, the second data, and the location data. Prevailing wage system 420 may retrieve wage data (e.g., from various regulatory body or policymaker databases or websites) based on the location data. Prevailing wage system 420 may identify one or more job classifications (e.g., terrazzo installer and terrazzo finisher) based on the first data and the second data. Prevailing wage system 420 may match the one or more classifications (e.g., terrazzo installer in Los Angela's, California) with the wage data ($150 per hour). Prevailing wage system 420 may automatically determine one or more compensations (e.g., $180 per hour including fringe benefits) based on the associated matched one or more classifications and wage data. The one or more compensations comprises one or more fringe benefit amounts and one or more fringe benefit allocations. Prevailing wage system 420 may generate a first GUI comprising the one or more compensations, and cause the system or another computing device (e.g., user device 502) to display the first GUI. Contractor may change the fringe benefit allocations via the user device 502 and prevailing wage system 420 may automatically and dynamically update the one or more compensations accordingly. Prevailing wage system 420 may generate fringe benefit statements associated with the one or more compensations and transmit the fringe benefits to another user device 502 or system associated with payroll processing to be submitted to a government or other regulatory agency for compliance. Otherwise, prevailing wage system 420 may transmit the fringe benefit statements directly to the government agency.

In one example, a contractor may engage a prevailing wage specialist to help with scheduling employees for a construction project to avoid unnecessary overtime. The contractor may provide first data (e.g., project description, project starting date, projected project completion data and an amount of time (e.g., hours) per classification required, number of employees associated with contractor, skills or past classifications of employees) and location data (e.g., an address of where the project will be located) to the prevailing specialist via a user device 502 or some other computing device. In turn, prevailing wage system 420 may receive or retrieve the first data and the location data. Prevailing wage system 420 may receive or retrieve wage data based on the location data. Prevailing wage system may generate a first schedule for one or more users (e.g., employees) based on the first data. Prevailing wage system 420 may cause one or more user devices to display a graphical user interface (GUI) including the first schedule for one or more users based on the first data. Prevailing wage system 420 may identify overtime based on first data and wage data. Prevailing wage system 420 may determine whether the first schedule comprises the overtime. Responsive to determining the first schedule includes the one or more overtime, prevailing wage system 420 may cause the one or more user devices to modify the GUI to include an indication of the overtime. Prevailing wage system 420 may generate a second schedule that does not include at least one overtime day or hour. In other words, prevailing wage system 420 may generate a second schedule with reduced overtime. Prevailing wage system 420 may cause the one or more user devices to further modify the GUI to overlay the second schedule.

Prevailing wage system 420 may cause the one or more user devices 502 to display a prompt requesting user input on whether the second schedule should replace the first schedule responsive to determining the first schedule includes the overtime. Prevailing wage system 420 may receive a first user input indicating that the second schedule should replace the first schedule and may cause the one or more user devices 50 to modify the GUI to remove the first schedule and include the second schedule.

In some examples, disclosed systems or methods may involve one or more of the following clauses:

Clause 1: An automated prevailing wage determination system comprising: one or more processors; and memory in communication with the one or more processors and storing instructions that, when executed by the one or more processors, are configured to cause the system to: receive or retrieve first data, and location data associated with the first data; receive or retrieve wage data based on the location data; identify one or more classifications based on the first data; match the one or more classifications with the wage data; automatically determine one or more compensations based on the associated matched one or more classifications, second data, and wage data, wherein the one or more compensations comprises one or more fringe benefit amounts and one or more fringe benefit allocations; generate a first graphical user interface (GUI) comprising the one or more compensations; and cause the system or another computing device to display the first GUI.

Clause 2: The automated prevailing wage determination system of clause 1, wherein the instructions are further configured to cause the system to: transmit the one or more compensations to a computing device configured to generate one or more reports with the one or more fringe benefit amounts and the one or more fringe benefit allocations based on the matched classifications, the first data, the wage data, and the second data; and cause the computing device to display the report in a second GUI.

Clause 3: The automated prevailing wage determination system of clause 2, wherein the instructions are further configured to cause the system to: generate one or more fringe benefit statements associated with the one or more classifications; and transmit the one or more fringe benefit statements to the computing device for display in a third GUI.

Clause 4: The automated prevailing wage determination system of clause 1, wherein the instructions are further configured to cause the system to: generate one or more reports comprising the one or more compensations based on the matched classifications, the first data, the wage data, and the second data; and cause the system or another computing device to display the one or more reports in a second GUI, wherein the one or more compensations further comprise wages.

Clause 5: The automated prevailing wage determination system of clause 4, wherein the instructions are further configured to cause the system to: generate one or more fringe benefit statements associated with the one or more classifications; and cause the system or the another computing device to display the one or more fringe benefit statements in the second GUI.

Clause 6: The automated prevailing wage determination system of clause 4, wherein the instructions are further configured to cause the system to: determine that prevailing wages apply to the first data; responsive to determining that the prevailing wages does not apply, generate and transmit a notification to a user device from which the first data was received indicating that the prevailing wages do not appear to be required; and responsive to determining the prevailing wages applies: receive or retrieve the wage data based on the location data; identify the one or more classifications based on the first data and the second data; match the one or more classifications with the wage data; determine the one or more compensations based on the associated one or more matched classifications and the wage data; generate the report comprising the one or more compensations based on the one or more matched classifications, the first data, the second data, and the wage data; and cause the system or another computing device to display the report in the first GUI.

Clause 7: The automated prevailing wage determination system of clause 1, wherein determining the one or more compensations comprises: identifying overtime rules associated with the location data; identifying at least one user with overtime according to the overtime rules; determining whether the overtime rules comprise an overtime benefit cap; responsive to determining that the overtime rules comprise the overtime benefit cap, determine overtime one or more fringe benefit amounts based on a rate less than one or more overtime rates and indicate in the GUI that the overtime benefit cap applies; and responsive to determining that the overtime rules do not comprise the overtime benefit cap, determine one or more overtime fringe benefits amounts based on the one or more overtime rates, wherein the one or more fringe benefit amounts comprise the one or more overtime fringe benefit amounts.

Clause 8: The automated prevailing wage determination system of clause 1, wherein the first GUI comprises the one or more compensations for one pay period.

Clause 9: The automated prevailing wage determination system of clause 1, wherein the instructions are further configured to cause the system to: automatically modify first GUI and the one or more compensations based retrieved or received predetermined increase data.

Clause 10: The automated prevailing wage determination system of clause 1, wherein the instructions are further configured to cause the system to: generate one or more compliance reports based on the one or more compensations; and cause the system or another computing device to display the one or more compliance reports in a second GUI.

Clause 11: The automated prevailing wage determination system of clause 1, wherein the second data comprises time data and associated geolocation data for at least one first user received from at least one first user device associated with the at least one first user.

Clause 12: The automated prevailing wage determination system of clause 11, wherein the instructions are further configured to cause the system to: set a geofence based on the first data and the location data; determine whether the associated geolocation data corresponds to the geofence; responsive to determining that the associated geolocation data corresponds to the geofence: store the time data received from the at least one first user device; generate a time sheet for the at least one first user associated with the at least one first user device with stored time data; transmit each time sheet to one or more second user devices for display in a second GUI; and receive approval of one or more time sheets from the one or more second user devices via the second GUI, wherein generating the one or more compensations is further based on the approved one or more time sheets.

Clause 13: The automated prevailing wage determination system of clause 1, wherein the second data comprises one or more images, and wherein the instructions are further configured to cause the system to: dynamically determine whether the matched one or more classifications are accurate; and responsive to dynamically determining at least one matched classification of the one or more matched classifications are not accurate: cause one or more user devices to display a second GUI comprising a prompt or indication of a discrepancy and one or more editable fields with at least one editable field of the one or more editable fields associated with the at least one matched classification; receive modified classification data via the at least one editable field; and modify the first GUI based on the modified classification data.

Clause 14: The automated prevailing wage determination system of clause 13, wherein dynamically determining whether the matched one or more classifications are accurate by comparing, via a machine learning model trained to detect similarities in images, the one or more images to one or more stored images associated with the one or more classifications.

Clause 15: The automated prevailing wage determination system of clause 13, wherein dynamically determining whether the matched one or more classifications are accurate by identifying, via a machine learning model trained to detect objects in images associated with the one or more classifications, an object in the one or more images indicative of the one or more classifications.

Clause 16: An automated prevailing wage determination system comprising: one or more processors; and memory in communication with the one or more processors and storing instructions that, when executed by the one or more processors, are configured to cause the system to: receive or retrieve first data and location data; receive or retrieve wage data based on the location data; generate a first schedule for one or more users based on the first data; cause one or more user devices to display a graphical user interface (GUI) comprising the first schedule for one or more users based on the first data; identify overtime based on first data and wage data; determine whether the first schedule comprises the overtime; and responsive to determining the first schedule comprises the overtime, cause the one or more user devices to modify the GUI to comprise an indication of the overtime.

Clause 17: The automated prevailing wage determination system of clause 16, wherein the instructions are further configured to cause the system to: generate a second schedule that reduces the overtime; and cause the one or more user devices to further modify the GUI to overlay the second schedule.

Clause 18: The automated prevailing wage determination system of clause 17, wherein the instructions are further configured to cause the system to: cause the one or more user devices to display a prompt requesting user input on whether the second schedule should replace the first schedule responsive to determining the first schedule comprises the overtime.

Clause 19: The automated prevailing wage determination system of clause 17, wherein the instructions are further configured to cause the system to: receive a first user input indicating that the second schedule should replace the first schedule; and cause the one or more user devices to modify the GUI to remove the first schedule and include the second schedule.

Clause 20: An automated prevailing wage determination system comprising: one or more processors; and memory in communication with the one or more processors and storing instructions that, when executed by the one or more processors, are configured to cause the system to: receive or retrieve first data, second data associated with one or more users, and location data; receive or retrieve wage data based on the location data; identify one or more classifications based on the first data and the second data; match the one or more classifications with the wage data; and automatically determine one or more compensations based on the associated matched one or more classifications and wage data, wherein the one or more compensations comprises one or more fringe benefit amounts and one or more fringe benefit allocations; generate one or more fringe benefit statements associated with the one or more classifications and based on the one or more fringe benefit amounts and the one or more fringe benefit allocations; and cause the system or another computing device to display the one or more fringe benefit statements; receive modified first data; identify one or more classifications changes based on the modified first data; generate one or more modified fringe benefit statements based on the one or more classifications; and cause the system or the another computing device to display the one or more modified fringe benefit statements in a graphical user interface (GUI).

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,”“module,”“system,”“server,”“processor,”“memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,”“third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods.

The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An automated prevailing wage determination system comprising:
one or more processors; and
memory in communication with the one or more processors and storing instructions that, when executed by the one or more processors, are configured to cause the system to:
receive or retrieve first data and location data associated with the first data;
receive or retrieve wage data based on the location data;
identify one or more classifications based on the first data;
match the one or more classifications with the wage data;
receive or retrieve second data associated with one or more users and the first data;
automatically determine one or more compensations based on the associated matched one or more classifications, second data, and wage data, wherein the one or more compensations comprises one or more fringe benefit amounts and one or more fringe benefit allocations;
generate a first graphical user interface (GUI) comprising the one or more compensations; and
cause the system or another computing device to display the first GUI.

2. The automated prevailing wage determination system of claim 1, wherein the instructions are further configured to cause the system to:
transmit the one or more compensations to a computing device configured to generate one or more reports with the one or more fringe benefit amounts and the one or more fringe benefit allocations based on the matched classifications, the first data, the wage data, and the second data; and
cause the computing device to display the report in a second GUI.

3. The automated prevailing wage determination system of claim 2, wherein the instructions are further configured to cause the system to:
generate one or more fringe benefit statements associated with the one or more classifications; and
transmit the one or more fringe benefit statements to the computing device for display in a third GUI.

4. The automated prevailing wage determination system of claim 1, wherein the instructions are further configured to cause the system to:
generate one or more reports comprising the one or more compensations based on the matched classifications, the first data, the wage data, and the second data; and
cause the system or another computing device to display the one or more reports in a second GUI,
wherein the one or more compensations further comprise wages.

5. The automated prevailing wage determination system of claim 4, wherein the instructions are further configured to cause the system to:
generate one or more fringe benefit statements associated with the one or more classifications; and
cause the system or the another computing device to display the one or more fringe benefit statements in the second GUI.

6. The automated prevailing wage determination system of claim 4, wherein the instructions are further configured to cause the system to:
determine that prevailing wages apply to the first data;
responsive to determining that the prevailing wages does not apply, generate and transmit a notification to a user device from which the first data was received indicating that the prevailing wages do not appear to be required; and
responsive to determining the prevailing wages applies:
receive or retrieve the wage data based on the location data;
identify the one or more classifications based on the first data and the second data;
match the one or more classifications with the wage data;
determine the one or more compensations based on the associated one or more matched classifications and the wage data;
generate the report comprising the one or more compensations based on the one or more matched classifications, the first data, the second data, and the wage data; and
cause the system or another computing device to display the report in the first GUI.

7. The automated prevailing wage determination system of claim 1, wherein determining the one or more compensations comprises:
identifying overtime rules associated with the location data;
identifying at least one user with overtime according to the overtime rules;
determining whether the overtime rules comprise an overtime benefit cap;
responsive to determining that the overtime rules comprise the overtime benefit cap, determine overtime one or more fringe benefit amounts based on a rate less than one or more overtime rates and indicate in the GUI that the overtime benefit cap applies; and
responsive to determining that the overtime rules do not comprise the overtime benefit cap, determine one or more overtime fringe benefits amounts based on the one or more overtime rates,
wherein the one or more fringe benefit amounts comprise the one or more overtime fringe benefit amounts.

8. The automated prevailing wage determination system of claim 1, wherein the first GUI comprises the one or more compensations for one pay period.

9. The automated prevailing wage determination system of claim 1, wherein the instructions are further configured to cause the system to:
automatically modify first GUI and the one or more compensations based retrieved or received predetermined increase data.

10. The automated prevailing wage determination system of claim 1, wherein the instructions are further configured to cause the system to:
generate one or more compliance reports based on the one or more compensations; and
cause the system or another computing device to display the one or more compliance reports in a second GUI.

11. The automated prevailing wage determination system of claim 1, wherein the second data comprises time data and associated geolocation data for at least one first user received from at least one first user device associated with the at least one first user.

12. The automated prevailing wage determination system of claim 11, wherein the instructions are further configured to cause the system to:
set a geofence based on the first data and the location data;
determine whether the associated geolocation data corresponds to the geofence;
responsive to determining that the associated geolocation data corresponds to the geofence:
store the time data received from the at least one first user device;
generate a time sheet for the at least one first user associated with the at least one first user device with stored time data;
transmit each time sheet to one or more second user devices for display in a second GUI; and
receive approval of one or more time sheets from the one or more second user devices via the second GUI,
wherein generating the one or more compensations is further based on the approved one or more time sheets.

13. The automated prevailing wage determination system of claim 1, wherein the second data comprises one or more images, and
wherein the instructions are further configured to cause the system to:
dynamically determine whether the matched one or more classifications are accurate; and
responsive to dynamically determining at least one matched classification of the one or more matched classifications are not accurate:
cause one or more user devices to display a second GUI comprising a prompt or indication of a discrepancy and one or more editable fields with at least one editable field of the one or more editable fields associated with the at least one matched classification;
receive modified classification data via the at least one editable field; and
modify the first GUI based on the modified classification data.

14. The automated prevailing wage determination system of claim 13, wherein dynamically determining whether the matched one or more classifications are accurate by comparing, via a machine learning model trained to detect similarities in images, the one or more images to one or more stored images associated with the one or more classifications.

15. The automated prevailing wage determination system of claim 13, wherein dynamically determining whether the matched one or more classifications are accurate by identifying, via a machine learning model trained to detect objects in images associated with the one or more classifications, an object in the one or more images indicative of the one or more classifications.

16. An automated prevailing wage determination system comprising:
one or more processors; and
memory in communication with the one or more processors and storing instructions that, when executed by the one or more processors, are configured to cause the system to:
receive or retrieve first data and location data;
receive or retrieve wage data based on the location data;
generate a first schedule for one or more users based on the first data;
cause one or more user devices to display a graphical user interface (GUI) comprising the first schedule for one or more users based on the first data;
identify overtime based on first data and wage data;
determine whether the first schedule comprises the overtime; and
responsive to determining the first schedule comprises the overtime, cause the one or more user devices to modify the GUI to comprise an indication of the overtime.

17. The automated prevailing wage determination system of claim 16, wherein the instructions are further configured to cause the system to:
generate a second schedule that reduces the overtime; and
cause the one or more user devices to further modify the GUI to overlay the second schedule.

18. The automated prevailing wage determination system of claim 17, wherein the instructions are further configured to cause the system to:
cause the one or more user devices to display a prompt requesting user input on whether the second schedule should replace the first schedule responsive to determining the first schedule comprises the overtime.

19. The automated prevailing wage determination system of claim 17, wherein the instructions are further configured to cause the system to:
receive a first user input indicating that the second schedule should replace the first schedule; and
cause the one or more user devices to modify the GUI to remove the first schedule and include the second schedule.

20. An automated prevailing wage determination system comprising:
one or more processors; and
memory in communication with the one or more processors and storing instructions that, when executed by the one or more processors, are configured to cause the system to:
receive or retrieve first data, second data associated with one or more users, and location data;
receive or retrieve wage data based on the location data;
identify one or more classifications based on the first data and the second data;
match the one or more classifications with the wage data; and
automatically determine one or more compensations based on the associated matched one or more classifications and wage data, wherein the one or more compensations comprises one or more fringe benefit amounts and one or more fringe benefit allocations;
generate one or more fringe benefit statements associated with the one or more classifications and based on the one or more fringe benefit amounts and the one or more fringe benefit allocations; and
cause the system or another computing device to display the one or more fringe benefit statements;
receive modified first data;
identify one or more classifications changes based on the modified first data;
generate one or more modified fringe benefit statements based on the one or more classifications; and
cause the system or the another computing device to display the one or more modified fringe benefit statements in a graphical user interface (GUI).
